(19) United States
(12) Patent Application Publication
(10) Pub. No.: US 2010/0299323 A1
(43) Pub. Date: Nov. 25, 2010

(54) SYSTEM, METHOD AND APPARATUS FOR RATING RISK

(76) Inventor: Edward Llewellyn Crook, New South Wales (AU)

Correspondence Address: BROOKS KUSHMAN P.C., 1000 TOWN CENTER, TWENTY-SECOND FLOOR, SOUTHFIELD, MI, 48075, US

(21) Appl. No.: 12/674,289

(22) PCT Filed: Aug. 18, 2008
(86) PCT No.: PCT/AU2008/001192

§ 371 Date: Feb. 19, 2010

(30) Foreign Application Priority Data
Aug. 21, 2007 (AU) 2007904479

(51) Int. Cl. G06F 17/30

(52) U.S. Cl. 707/723; 707/E17.014

(57) ABSTRACT

The present invention relates to a method, system and apparatus for rating risk and in particular to a system for rating public health and safety risks, including monitoring and reviewing compliance with such risks, among Suppliers in goods and services industries. The invention has been developed primarily for use as a means for food providers and consumers to review standardised results of compliance testing and risk rating in goods and services industries such as the food supply industry and to assist consumers to make informed choices about Suppliers such as food Suppliers.

### FIELD OF THE INVENTION

The present invention relates to a method, system and apparatus for rating risk and in particular to a system for rating public health and safety risks, including monitoring and reviewing compliance with such risks, among Suppliers in goods and services industries.

The invention has been developed primarily for use as a means for food providers and consumers to review standardised results of compliance testing and risk rating in goods and services industries such as the food supply industry and to assist consumers to make informed choices about Suppliers such as food Suppliers. However, it will be appreciated that the invention is not restricted to this particular field of use.

### COPYRIGHT NOTICE

This document is subject to copyright. The reproduction, communication and distribution of this document is not permitted without prior consent from the copyright owner, other than as permitted under section 226 of the Patents Act 1990.

### DESCRIPTION OF THE PRIOR ART

In Australia and New Zealand, the Food Standards Code sets out standards for food safety applicable to the food supply industry. These standards have been developed by Food Standards Australia New Zealand (FSANZ), a statutory authority established to develop food standards, codes of practice and content and labelling requirements for food sold in Australia and New Zealand. The FSANZ also has responsibility for developing nationally uniform food safety legislation for Australia including primary production and processing standards within Australia.

Despite the uniformity of codes of practice for food preparation applicable across Australia, compliance with and the performance of food safety standards can be variable. This is because responsibility for policing and enforcement of standards lies with local (State or Territory) government authorities. Factors that appear to limit the consistent policing of food safety standards include:
(a) shortages of resources and funding; and
(b) the limited sharing of information regarding compliance policing by local authorities.

Known systems in the United Kingdom for placing ratings for compliance with food safety requirements, known as “scores-on-doors”, on the doors or service counters of food supply premises provide little information to consumers and only then at the individual food Supplier's premises. Known systems for making compliance scores available on the internet provide little information about the reasons for poor performance in a compliance audit. This information is of interest to consumers and of assistance to authorities attempting to locate potential sources of food borne pathogens (for example, in an “outbreak” of food poisoning). For example, known systems do not record or report for consumers:
(a) the type(s) of pathogens found on the premises or in food prepared by the Supplier. This information is of interest to consumers and of assistance to health authorities attempting to locate potential sources of food borne pathogens (for example, in an “outbreak” of food poisoning);
(b) the history of compliance performance (including details of pathology testing) of individual Suppliers. For example, consumers may be interested in knowing whether an individual Supplier has been found to supply food contaminated by particular pathogens in their most recent audit or during any recent audits. A consumer researching a holiday away from home would find it useful to access this information prior to the holiday. Carers of young children or consumers whose health is compromised (and therefore might be more susceptible to food-borne illnesses) would also be interested in accessing this information prior to travelling to the relevant food Supplier's premises;
(c) standardised data that would enable interested parties to compare compliance performance or rating to risk across geographical regions—for example, our consumer researching a holiday away from home would find comfort in knowing that a particular rating means the same standard of performance anywhere across Australia. An analogous rating system (in the sense of a standardised rating) would be well known restaurant rating systems, in which restaurants anywhere that achieve a particular rating would generally be considered to meet the same high standard of culinary excellence.

A further disadvantage of known systems for rating compliance is that they only publish the performance of establishments in relation to food safety and hygiene. Other information that is important to consumers is not measured. For example, consumers with life-threatening food allergy (e.g. to peanuts, mushrooms or seafood) would be interested in knowing the rating of a particular establishment for risk of cross-contamination of food products with common, known allergenic foods. Consumers with coeliac disease or gluten intolerance need to know, for example, that potato chips have not been fried in the same oil as battered fish. Vegetarians need to know that their food has not been contaminated with meat.

Yet another disadvantage of the prior art is that no known systems provide and report ratings to risk for public health or safety generally. The risk of exposure to well known airborne allergens (e.g. Legionella) or common parasites (e.g. bed bugs) in hotels or aged care facilities in any given geographic region would be of interest to consumers. Compliance with noise regulations is another consideration for consumers. Environmental noise from transportation (cars, trucks and airplanes) and stationary motors (air conditioning units, lifts and refrigeration motors) would be of interest to consumers selecting a hotel, as would the acoustic performance of certain cafes and restaurants in selecting a venue for a business meeting. Compliance with anti-smoking legislation and the risk of exposure to passive smoke is important to many consumers.

Further, most known systems provide little detail about poor performance. One known system that does provide the details of noncompliance in the food supply industry is the NSW Food Authority “name and shame” register (published on the Authority's website). The intention is to notify the public about food Suppliers who have breached food safety laws. The register provides the name and address details of food Suppliers who have been convicted of an offence (breach of food safety laws) and a brief description of the nature of the offence, as well as a link to the actual judgement.

The “name and shame” register and like prior art suffer the following disadvantages including:
(a) consumers looking for a food Supplier (e.g. restaurant) are unlikely to cross reference the register;
(b) legal judgements are not typically written in language that the average consumer will read and readily understand;
(c) as the register grows, consumers will need to wade through individual entries to obtain the information that is of interest and relevance to them—there is no easily accessible way to find out, for example, which food Suppliers in a particular region have carried Salmonella or have failed to maintain their premises at the requisite standard of cleanliness. Further, consumers are unable to gauge performance of a food Supplier in one region against a food Supplier in another region, where higher compliance with standards may be the result of lower levels of policing rather than better compliance with the relevant standards.

Other known systems such as the UK Chartered Institute of Environmental Health (CIEH) “scores-on-doors” system in the United Kingdom and a similar system operated by the Papakura District Council in New Zealand, focus only on compliance with food safety or hygiene regulations. They do not test for food-borne pathogens, which is of increasing concern to consumers.

Further, the publication of the information at the relevant individual premises in known systems such as “scores-on-doors” suffers the disadvantage that consumers cannot access the'information until they are at the actual premises.

Additionally, systems such as the Papakura District Council system, publishes the grades of all food premises licensed by the Council on the Council website. However, this only occurs “from time to time” so is not a timely reporting of the information and again suffers from the disadvantage that consumers are required to cross reference a separate website when trying to choose a food Supplier.

### OBJECT OF THE INVENTION

It is an object of the present invention to overcome or ameliorate at least one of the disadvantages of the prior art, or to provide a useful alternative.

According to one aspect of the invention there is provided a system for rating risk including:
a) a risk information Data Repository having data items wherein said data items include:
   i. a register of details about one or more Suppliers including each said Supplier's location(s), specialisation(s) and capacity(s);
   ii. data obtained by testing, measuring and/or auditing one or more Criterion at specified sampling intervals at each said Supplier's premises; and
   iii. a normalised score for each said Supplier, derived from said data, wherein said score enables comparison such that one or more said Suppliers are enabled to be compared:
      A. with each other;
      B. within said specified Criterion;
      C. within specified locations;
      D. with said Suppliers in other locations;
      E. with said Suppliers with similar said normalised scores for said specified Criterion; and
      F. with their own said normalised scores against said specified Criterion over time;
b) a search facility wherein:
   i. said Data Repository is enabled to be searched by one or more said data items; and
   ii. search results are enabled to be sorted by one or more said data items including said Supplier, location, said normalised score, time, and one or more said Criterion;
c) a reporting facility wherein said search results are enabled to be sorted and published, including as a network-linked computer-generated report.

According to another aspect of the invention there is provided a method for rating risk including the steps of:
a) accessing a risk information Data Repository having data items wherein said data items include:
   i. a register of details about one or more Suppliers including each said Supplier's location(s), specialisation(s) and capacity(s);
   ii. data obtained by testing, measuring and/or auditing one or more Criterion at specified sampling intervals at each said Supplier's premises; and
   iii. a normalised score for each said Supplier, derived from said data, wherein said score enables comparison such that one or more said Suppliers are enabled to be compared:
      A. with each other;
      B. within said specified Criterion;
      C. within specified locations;
      D. with said Suppliers in other locations;
      E. with said Suppliers with similar said normalised scores for said specified Criterion; and
      F. with their own said normalised scores against said specified Criterion over time;
b) utilising a search facility wherein:
   i. said Data Repository is enabled to be searched by one or more said data items; and
   ii. search results are enabled to be sorted by one or more said data items including said Supplier, location, said normalised score, time, and one or more said Criterion;
c) utilising a reporting facility wherein said search results are enabled to be sorted and published, including as a network-linked computer-generated report

According to yet another aspect of the invention there is provided an apparatus for rating risk including:
a) a risk information Data Repository having data items wherein said data items include:
   i. a register of details about one or more Suppliers including each said Supplier's location(s), specialisation(s) and capacity(s);
   ii. data obtained by testing, measuring and/or auditing one or more Criterion at specified sampling intervals at each said Supplier's premises; and
   iii. a normalised score for each said Supplier, derived from said data, wherein said score enables comparison such that one or more said Suppliers are enabled to be compared:
      A. with each other;
      B. within said specified Criterion;
      C. within specified locations;
      D. with said Suppliers in other locations;
      E. with said Suppliers with similar said normalised scores for said specified Criterion; and
      F. with their own said normalised scores against said specified Criterion over time;
b) a search facility wherein:
   i. said Data Repository is enabled to be searched by one or more said data items; and
   ii. search results are enabled to be sorted by one or more said data items including said Supplier, location, said normalised score, time, and one or more said Criterion;
c) a reporting facility wherein said search results are enabled to be sorted and published, including as a network-linked computer-generated report.

Preferably, the risk information Data Repository is enabled to access publicly available information including health authority audits and restaurant critic reviews, such that:
a) said search facility is enabled to search and sort said publicly available information along with said data items within said Data Repository;
b) said publicly available information is enabled to be reconciled with said data items within said Data Repository, including with said normalised score for a specified Supplier; and
c) said reporting facility is enabled to sort and publish said reconciled data items, including as a network-linked computer-generated report.

According to the invention there is additionally provided a system, method and apparatus for rating risk substantially as herein described with reference to the accompanying drawings.

### BRIEF DESCRIPTION OF THE DRAWINGS

A preferred embodiment of the invention will now be described, by way of example only, with reference to the accompanying drawings in which:

FIG. 1 is a flow diagram of a system for reporting to risk according to the invention.

FIG. 2 illustrates schematically the public health and safety risks that may be ranked in a preferred embodiment of the invention.

### DETAILED DESCRIPTION

The present invention relates to a method, system and apparatus for rating risk, including monitoring and reviewing compliance, and in particular for rating public health and safety risks among Suppliers in goods and services industries such as the food supply industry.

A preferred embodiment provides consumers (which may include Suppliers, Providers and Regulators or any other groups or person(s) with a public or private interest) with access to a system that ranks Suppliers according to a range of public health and safety risks. Rankings are provided as a normalised score to enable comparison by consumers between Suppliers, across time and/or across geographic regions. The preferred embodiment includes a centralised risk information Data Repository, such as a database, and a search facility whereby consumers can perform searches of the Data Repository to obtain:
(a) rankings according to one or more Criterion that are relevant to the individual consumer;
(b) immediate re-rankings based on a modified choice of Criterion (e.g. to exclude or include Criterion from previous searches);
(c) more detailed information underlying a ranking (e.g. the type of food borne pathogens found on a particular food Supplier's premise).

In the preferred embodiment, there is a reporting facility whereby the individually customised and printable search results are downloadable by consumers over the internet or using wireless communications technology, so they can be accessed in a manner and at a time convenient to the consumer and/or carried with the consumer, if desired. The preferred embodiment of the invention also provides a facility for consumers to reconcile search reports with other publicly available information including reports from health authorities, legal decisions and/or critic reviews such as restaurant or hotel reviews.

A person skilled in the art would appreciate that instead of using a “centralised database”, other arrangements of data repository are envisaged for storing, sorting, ranking and accessing information, such as non-database files and/or distributed files. Collectively, all such arrangements of information are referred to as a Data Repository.

A preferred embodiment of the present invention will now be described by reference to the drawings. The following detailed description in conjunction with the figures provides the skilled addressee with an understanding of the invention. It will be appreciated, however, that the invention is not limited to the applications described below.

### Dictionary of Defined Terms

Table 1 is a dictionary of terms defined according to the invention. Terms defined in Table 1 are denoted with the use of capitalisation throughout the document. If a term is not capitalised then its plain meaning is to be construed, unless otherwise specified.

TABLE 1
Dictionary of defined terms

| Term | Description |
|---|---|
| Criterion | Includes, but is not limited to the presence and/or |
| | measurement of one or more of the following |
| | (i) food borne pathogens (e.g. Salmonella, avian |
| | influenza, bovine spongiform encephalopathy, |
| | etc); |
| | (ii) hygiene practices resulting in cross contamination |
| | of food; |
| | (iii) hygiene measures such as location of “food |
| | stations”, cleaning intervals, etc. |
| | (iv) airborne pathogens (e.g. Legionella); |
| | (v) cleaning of water-cooling, air-handling, |
| | evaporative cooling, humidifying and hot and |
| | warm-water systems; |
| | (vi) rodents, pests, common human parasites and |
| | vector borne diseases; |
| | (vii) processes for minimising exposure to rodents, |
| | pests, common human parasites and vector borne |
| | diseases; |
| | (viii) air pollutants (poor air quality) - e.g. wood |
| | heaters, mould, dampness, motor vehicle |
| | emissions, air toxins, cigarette smoke, etc; |
| | (ix) risk of exposure to environmental and food |
| | allergens; |
| | (x) personal safety; |
| | (xi) “adverse events” associated with an individual |
| | Supplier over time; |
| | (xii) noise hazards and acoustic characteristics; |
| | (xiii) radiation including non-ionising radiation; |
| | (xiv) environmental contaminants (“green food” rating); |
| | (xv) critical meta-analysis based on publicly available |
| | information such as published critics reviews of a |
| | food Supplier, hotel, etc. |
| Data | Any means for storing, sorting, ranking and accessing |
| Repository | information, such as a database but also including |
| | non-database files and/or distributed files |
| Food | Any business which, in the course of trade, prepares |
| Supply | and/or supplies food for consumption by the public. This |
| Business | includes restaurants, cafes, take-away food bars, “fast” |
| (FSB) | food businesses, clubs, school canteens, event venues, |
| | public bars |
| Food Supply | Any premises used by a FSB to prepare and/or supply |
| Establishment | food for consumption by consumers |
| (FSE) | |
| Supplier | A goods and services Supplier is any trader who supplies |
| | goods or services to consumers. The term is used in this |
| | invention to include the supply chain for an individual |
| | Supplier. For example, a café is a Supplier in the food |
| | supply industry. Details of an individual café are |
| | recorded in the Data Repository of the preferred |
| | embodiment of the invention including details of the |
| | produce Supplier(s) to the café and their Supplier(s). |
| | A cleaner (or cleaning corporation) may be a service |
| | Supplier to a Café. |

The elements of the invention are now described under the following headings:

What the Invention does

The present invention provides a system, method and apparatus for reporting to risk. In a preferred embodiment, it provides a system for reporting to public health and safety risks in goods and services supply industries such as the food supply industry; however, it may also be used for reporting and rating risks associated with individual Suppliers in the hospitality industry (including hotels, hostels, ski lodges, public bars and other establishments providing residential accommodation), in hospitals, jails, aged care facilities, child care centres, boarding schools, or for rating compliance to other public health and safety requirements.

The preferred embodiment of the invention provides a means for:
(a) assessing the performance of a Supplier such as a restaurant or cafe in relation to a specified Criterion or risk (examples provided below);
(b) taking the results of such assessments and normalising the data into a score to enable detailed comparison against another variable (e.g. comparisons across time, location (across geographic regions), across Suppliers)—this also provides a mechanism for monitoring or mapping performance according to such variables, including for public health purposes (e.g. locating possible sources of outbreaks of food-borne disease);
(c) publishing the normalised score in a form that is accessible and meaningful to consumers;
(d) updating data and scores dynamically when the results of new assessments become available, such that the data and scores more accurately reflect current, very recent or the rate of change in the performance of a Supplier.

Examples of the kinds of Criterion or risks that may be specified include:
(a) compliance with food safety and hygiene standards—for example:
   (i) testing for food borne pathogens (e.g. Salmonella, avian influenza, bovine spongiform encephalopathy) in Food Supply Businesses or Food Supply Establishments;
   (ii) testing for cross contamination of food as a result of poor hygiene practices such as preparing salad ingredients on a surface on which raw chicken had previously been prepared for cooking;
   (iii) assessing the standard of hygiene measures such as the frequency and adequacy of hand washing, bench-top washing, cleanliness of dish cloths and tea towels, the placement of “cleaning stations” (to clean and stack used crockery and cutlery and dispose of waste) close to diners or to food being prepared for diners, or the ability to clean implements (e.g. cracked china, worn implements made from wood).
(b) compliance with environmental health requirements—for example:
   (iv) testing for airborne pathogens (e.g. Legionella) and proper installation, maintenance and cleaning of water-cooling, air-handling, evaporative cooling, humidifying and hot and warm-water systems in hotels, conference venues, office blocks or other public buildings;
   (v) testing for the presence of rodents, pests (e.g. cockroaches, fleas, mosquitoes), common human parasites (e.g. head lice, bed bugs in hostels or aged care facilities), vector borne diseases (e.g. dengue, yellow fever and malaria from mosquito bites in any residential accommodation service that has a garden or in cafes or restaurants with open areas for dining), and the adequacy of systems and processes for minimising exposure to such risks (e.g. in restaurants, cafes or public bars with open areas for eating);
   (vi) testing for air pollution (poor air quality)—e.g. wood heaters, unflued gas heating, mould, dampness, motor vehicle emissions, air toxins—e.g. in cafes, restaurants or public bars providing road-side tables for dining;
   (vii) risk of exposure to environmental and food allergens—e.g. a common allergenic plant such as a wattle tree in a courtyard area for eating, or exposure to food allergens from inadequate food preparation procedures to prevent cross contamination during handling, preparation and serving of food (e.g. careful cleaning of utensils when preparing allergenic foods) or the use of allergenic additives such as MSG, peanut oil and so on;
(c) the environmental or eco-friendliness of the Supplier (“green food” rating)—e.g. the consumption of energy and resources (electricity, gas, water) by an individual FSB during the food production process, the contamination of waste water by the FSB, the extent to which raw ingredients or produce are organic, or the levels of pesticides, hormones or other contaminants present in foods;
(d) other safety risks—e.g. personal safety on the premises or the security of credit card details or other personal information provided to the Supplier;
(e) recording the number and type of “adverse events” associated with an individual Supplier over time. Examples of adverse events include confirmed cases of food poisoning associated with a FSB, the number of falls on the premises of a FSE (workers, clientele or any third party visitor to the premises) or the number of severe allergic reactions associated with a FSB. In one arrangement, this information will be provided as raw data (register of events) and as a normalised score (risk of certain adverse events occurring). An alternative arrangement will provide a means for consumers to report an adverse event against an individual Supplier (subject to appropriate verification to ensure accuracy and to minimise fraudulent reporting);
(f) meta-analysis of a Supplier's performance based on publicly available information such as critic reviews of any given Supplier. For example, if an individual Supplier such as a restaurant has been the subject of, say, ten publicly available critic reviews, the Data Repository will contain information that reflects the mean and mode ratings given by restaurant critics on a scale from appalling to excellent. This meta-analysis information is provided as statistical data (e.g. two out of three) or qualitative data (e.g. poor, good, excellent) and is provided either alone or combined with the Supplier's normalised score, depending on the consumer's search query. Other examples of publicly available information include:
a. where an individual Supplier had been the subject of legal action and received adverse findings against it in, say, four out of five legal decisions;
b. health authority reports;
c. or environmental assessments.

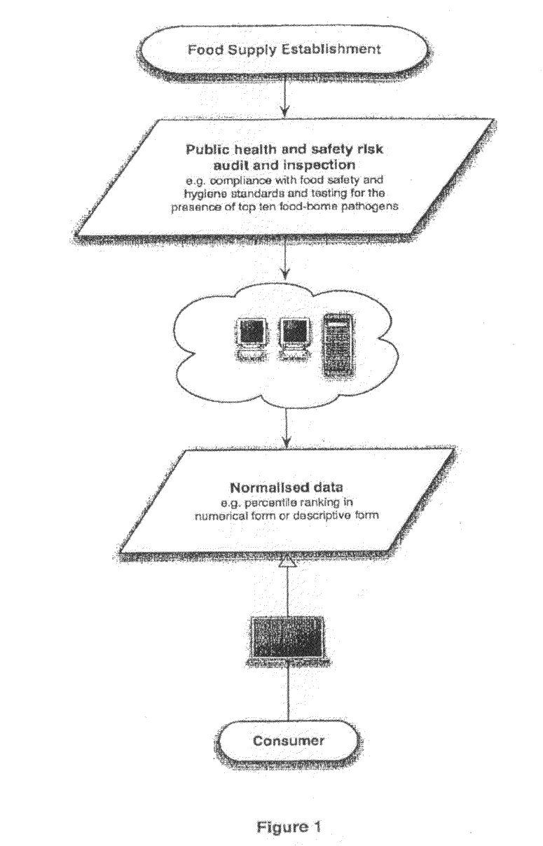

FIG. 1 is a flow diagram of a system for reporting public health and safety risk, including monitoring and reviewing compliance with food safety standards and testing for food borne pathogens, according to a preferred embodiment of the invention.

### Sources of Information

The present invention provides a means for consumers to access the rating of individual establishments or businesses such as a café or restaurant, hotel, conference venue or office block according to public health and safety risks.

In a preferred embodiment, the invention provides information published on a website, including access to a centralised Data Repository of information, as well as in print format for display at the relevant premises and as a printed compilation (e.g. in book format).

One or more Suppliers are enabled to request that a rating of their goods and/or services be established without publication of its ratings. In this situation all data is excluded concerning the Supplier—this is to protect against a Supplier nominating the selective publication of favourable ratings. Consequently a rating can be established on a confidential basis with respect to specific requests by Suppliers.

For Supplier that request that their ratings are published, Consumers wishing to obtain more information about an individual Suppliers and/or FSE can type in a search request and download a report from the Data Repository (e.g. over the internet prior to attending the premises) or at the relevant premises.

For example, a poster displaying the FSE's ranking may be embedded with a “smart tag” (radiofrequency identification device) or conceal a Bluetooth hotspot that will deliver the report (or a standardised report) to a programmable device held by the consumer (e.g. a mobile phone, an MP3 player, a personal organiser, a portable hard drive, a laptop or any other device with adequate memory).

The preferred embodiment of the invention provides a centralised Data Repository that contains the results of public health and safety audits and also cross references and/or links to other reports or information available, such as on the internet and published in newspapers or magazines. For example, the preferred embodiment provides a link to relevant information made publicly available by local authorities or to published restaurant guides or reviews by food critics. The information is presented as a normalised score so that it can be easily accessed and understood by consumers from a single centralised source.

Consumers can “drill down” into the information by performing personalised, detailed searches of the Data Repository, so that only Criterion of relevance to the individual consumer will be included in the search. Search terms may include key issues or key words, or location. For example, a consumer can search for restaurants in a particular district and that have a good (i.e. low) rating for allergenic risk. Alternatively, another consumer searching the Data Repository for restaurants in the same district and who is not concerned about allergenic risk will have allergenic risk excluded from the relative rankings of the search results. This enables consumers to use the invention to obtain meaningful rankings of Suppliers such as FSEs. The search reports can be printed or downloaded by consumers when and where they want the information.

### (i) How do Consumers Access the Information?

The preferred embodiment of the invention provides a centralised system for timely publishing and updating of, and access to, public health and safety risk information. This preferred embodiment enables the information to be accessed remotely from the relevant premises, including over the internet, and in a timely manner. It also enables cross references or links to third party sources of information, such as to publishers of restaurant guides or to local authorities. Known systems such as the “scores-on-doors” system focus only on compliance with food safety or hygiene regulations. They do not test for food-borne pathogens, which is of increasing concern to consumers.

The preferred embodiment of the invention expands the scope of testing of individual Suppliers to testing for food-borne pathogens and also to assessing for other public health risks (e.g. pest inspections, allergenic risk, and so on). Additionally, the preferred embodiment provides consumers with remote access to the relevant information as well as virtually instantaneous to detailed reports on an individual FSE or on all FSEs in a particular region on request.

The Papakura District Council publishes the grades of all food premises licensed by the Council on the Council website. However, this only occurs “from time to time” so is not a timely reporting of the information and again suffers from the disadvantage that consumers are required to cross reference a separate website when trying to choose a food Supplier. The present invention overcomes these disadvantages by providing regular testing of suppliers and dynamically updating test scores (that is, updating test scores in a timely manner). The scores provided are normalised so that consumers can compare the scores across Suppliers, over time and across regions.

The CIEH “scores-on-doors” system covers the ratings of 44 local authorities across the UK. This information is available online. However, the scores are published by the individual relevant local authorities. Therefore, no centralised source of information exists for finding and comparing scores of Food Supply Businesses across the UK. Further, the detail published varies from local authority to local authority. In some areas, the information on inspection reports is scant and consumers need to rely on requests under the Freedom of Information Act to obtain information about the hygiene of their local café.

The present invention provides summaries of public health and safety audits in the form of a normalised score. The score takes into account compulsory Criterion such as compliance with food safety and hygiene standards, and additional Criterion specified by the consumer (e.g. if the consumer requests a score based on allergenic risk then that information is taken into account in calculating the final score for an individual FSE). The scores are presented as a percentile ranking (in numerical or descriptive format), which indicate the kinds of risks associated with the particular FSE. However, consumers interested in obtaining more information (e.g. the specific food borne pathogens found on a particular premises or the incidence of food poisoning over time associated with a specific FSE) can perform a search of the Data Repository and download a report with further detail of the FSE's score. All of this information is available from a centralised Data Repository that also links to other relevant information providers so consumers are not required, for example, to visit numerous websites to collate information. The preferred embodiment of the invention also provides a broader scope of information to consumers than is provided by any known system.

### (ii) What Information is Provided to Consumers?

The preferred embodiment of the invention provides a means for delivering information to the public based on measurements of objective Criterion—generally as stipulated in a relevant regulation, standard or code. For example, in relation to a FSB it will be compliance with food standards and codes, as well as the relative risk of exposure to other common public health and safety risks for that FSB (see below for further detail of other public health and safety risks that will be monitored and ranked by the present invention). The information will be published on line for ease of access and timeliness of reporting, as well as in print format (e.g. as a book, a newsletter, looseleaf periodical, or other periodical format).

The present invention enables raw measurements for any particular FSB or FSE to be normalised to enable direct comparison by a consumer of one FSE with another FSE across geographic regions. This provides an objective measure of performance that can be relied on by consumers from region to region, country to country.

The normalised score is updated dynamically to provide current or very recent ratings of performance to be available in a timely manner. Known systems suffer the disadvantage that ratings are only performed annually.

The present invention also provides a means for comparing risk of exposure to common public health and safety risks in any Supplier to the public, such as a Food Supply Establishment, a hotel, a jail, an aged care facility, a ski lodge or a school. For example, an individual FSE is scored or rated according to the risk of exposure to, say:
(i) the top ten (most common or most dangerous) food-borne pathogens;
(ii) top ten food allergens;
(iii) top ten environmental allergens (e.g. the presence of an allergenic plant in the premises);
(iv) noise hazards and acoustic characteristics (e.g. “meeting meter” ranking for appropriateness of noise levels for the FSE as a business meeting venue);
(v) non-ionising radiation (e.g. if there is a mobile phone relay station, main transmission power lines or power station close to the premises);
(vi) environmental contaminants (“green food” rating)—this ranking includes, for example, an assessment of the extent to which a FSE relies on produce that is organic, free range, hormone-free, pesticide-free and/or free-from-genetic-modification, as well as being a rating of energy or resource consumption by the FSE during the production process (normalised to enable comparison between individual Suppliers, across region or over time);
(vii) personal security and safety risks—e.g. security of credit card details provided for payment to a FSE, hotel or other Supplier; and/or
(viii) adverse events, based on the frequency of adverse events (e.g. falls on the premises) associated with the FSE over time.

In one embodiment of the invention, the results for various individual premises are stored centrally and the comparative results (normalised rankings) made available to consumers online (as well as on the individual premises) as a weighted percentile ranking in numerical form or summarised as a descriptive level of achievement, such as a “gold”, “silver” or “bronze” ranking. The details of the ranking will enable consumers to ascertain, for example, whether certain pathogens were present at the premises, or whether the premises adequately protected consumers against the risk of cross-contamination by potentially lethal allergenic foods.

(iii) Adaptation to Personal or Specific Group Requirements

The preferred embodiment of the invention provides a means for ranking the public health risks associated with a particular Supplier that are of particular relevance to an individual or specific group of consumers. Consumers are able to determine which risks will be included in the final score. For example, if a consumer is not concerned about noise hazards or non-ionising radiation, these data are excluded from the search results (i.e. normalised score). Alternatively, if the risk of exposure to allergens is not a concern, the normalised score (or scores for a group of Suppliers) is (are) re-normalised without the data about allergenic risk, so a re-ranking of only the desired Criterion (i.e. Criterion specified by the consumer) can be made.

Likewise, if a consumer is concerned about an allergy (such as a peanut allergy) then only the Suppliers such as FSE which do not use peanut derived products will be included in the normalised scores. Therefore, the findings of the invention's risk ratings can be adapted to the needs of the individual.

Further, consumers who wish to obtain further information underlying a normalised (or re-normalised) score can do so by performing a search of the Data Repository with the appropriate search terms. This can reveal details, for example, of the types of food borne pathogens found on an individual premises or all premises within a given region that have carried Salmonella in the previous six months.

### Sources of Public Health and Safety Risk in a Food Supply Establishment

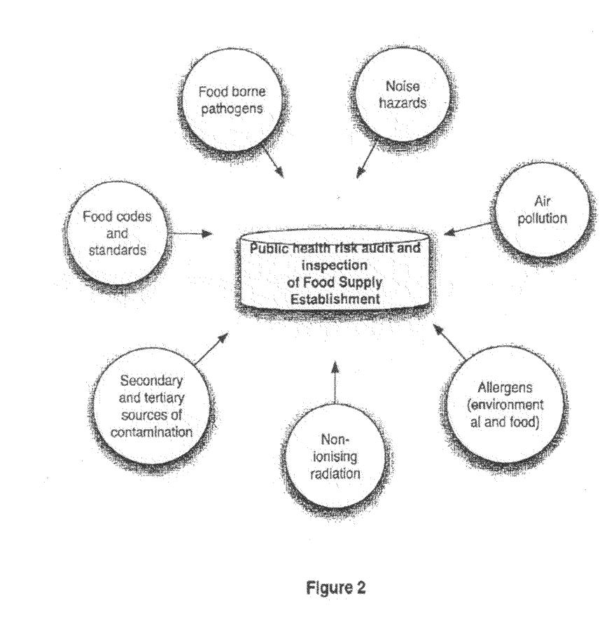

The preferred embodiment of the invention provides a means for assessing, rating and reporting public health and personal safety/security risks of various businesses and establishments—for example, in the food supply, aged care or hospitality industries—both for the individual consumer and for the broader community. FIG. 2 illustrates schematically the data inputs that may be included in the final ranking of a FSE in a preferred embodiment of the invention. Shown schematically are the public health and safety risks that may be taken into consideration by the preferred embodiment of the invention in calculating a ranking for an individual Food Supply Establishment.

These risks include:
(a) noncompliance with FSANZ food code/standards;
(b) presence of food borne pathogens (the preferred embodiment of the invention can also provide, for example, ratings for “top ten pathogens”);
(c) compliance with noise control regulations, levels of vibration and other noise hazards (the “meeting meter” ranking referred to above);
(d) air pollution (including odours, chemicals, cigarette smoke, toxins, airborne pathogens);
(e) exposure to allergens (e.g. common allergenic plants such as wattle trees, dustmite, food allergens);
(f) secondary and tertiary sources of contamination such as:
   (i) how does food/produce enter the establishment? Is meat processed in unlicensed premises or delivered by an unlicensed delivery vehicle;
   (ii) metal contamination of major fish species available for human consumption;
   (iii) is sugar or salt left in uncovered bowls on tables (creating an opportunity for contamination by consumers—e.g. children putting fingers in bowl, or a teaspoon re-used by consumer to take sugar);
   (iv) the extent of exposure to pesticide or hormonal contaminants in food;
   (g) exposure to non-ionising radiation (e.g. low frequency radiation found with power transmissions, radiowaves (used for mobile phones) and sunlight—this information would be of interest to investors in new building developments/housing developments;
   (h) environmental or eco-friendliness of the Supplier (“green food” rating), including a rating of energy and/or resource consumption by the Supplier, recycling practices, reduction of waste including contamination of waste water, and the extent of reliance on organic, “GM-free”, free range produce;
(i) inadequate personal security or safety measures to protect clientele and their personal details (e.g. credit card information); and/or
(j) other public health or safety risks—e.g. environmental health risks such as risk of exposure to air borne pathogens, vector borne disease, common human parasites, non-ionising radiation, or the safety of physical premises (compliance with building regulations, say, as to hand rails on staircases or balconies).

### Sampling: Scope and Frequency

The present invention provides a system that enables broader and more frequent sampling than known systems and for reporting performance dynamically. The preferred embodiment of the invention assesses individual Suppliers according to broader Criterion than known systems and also provides more information to consumers than known systems. For example, the preferred embodiment extends the assessment and reporting beyond compliance with food safety and hygiene practices to other considerations of concern to consumers, including environmental health and safety issues. In one embodiment, the invention ties rankings of adequacy of food safety and hygiene practices to rankings of risk of exposure to top ten food-borne pathogens. In alternative embodiments, other common public health and safety risks (including noise hazards, air pollution, airborne pathogens and/or other risks) will also be assessed.

Reporting is in a format that is readily understood by consumers but that will give consumers sufficient information to make an informed assessment of a Food Supply Establishment (or hospitality provider, aged care provider, school, and so on) based on the relative risk of exposure to certain public health and safety risks. Reports are available in print format or downloadable from the Internet or by wireless communications technology so that a traveller can access the reports remotely or carry the report with them if desired.

Businesses or establishments ranked by the preferred embodiment such that they are categorised according to the level of public health or safety risk present. The frequency of audits/inspections will be higher for higher risk businesses. The frequency or timing of audits may also be varied according to the nature of the business and to reflect seasonal demands—for example:
(a) coastal resorts will require more frequent testing in summer;
(b) resorts in snow fields will require more regular testing in the winter months; and
(c) large hotels and food production units in large cities may require regular testing all year round.

The advantage is that if a business scores poorly in one audit, it does not need to wait one full year to improve its score. Conversely, the advantage to consumers is that the score reflects the establishment's current or recent standards of performance.

The preferred embodiment of the invention provides consumers with a means to make their decisions based on a range of Criterion that may be of interest or relevance to them, rather than basing their decisions on the much more narrow Criterion currently available to them through known systems. Consumers choosing a restaurant may be swayed by the cleanliness of the premises, but are also likely to be swayed by other considerations such as:
(a) how noisy the premises are;
(b) the presence of an allergenic plant in the courtyard of a particular premises;
(c) the risk of exposure to or cross contamination by allergenic foods such as mushrooms or peanuts or by contaminants such as pesticides or hormones;
(d) the adoption of environmental and eco-friendly (“green food”) standards;
(e) the security of a customer's credit card details; and/or
(f) the safety of the physical environment (e.g. distance and separation of toilets from kitchen or serving areas, cleanliness of toilets, adequacy of hand railings on staircases and balconies, precautions taken to protect clientele from spillages, etc).

The preferred embodiment of the invention also provides a means for a consumer to obtain rankings for Suppliers based on the public health and risks of interest to the individual consumer. Consumers can quickly and easily perform new searches of the Data Repository provided by the preferred embodiment, such that Suppliers can be re-ranked according to modified Criterion and the results obtained in a timely and efficient manner.

Although the invention has been described with reference to specific examples, it will be appreciated by those skilled in the art that the invention may be embodied in many different other forms.

1. A system for rating risk including:
a) a risk information Data Repository having data items wherein said data items include:
i. a register of details about one or more Suppliers including each said Supplier's location(s), specialisation(s) and capacity(s);
ii. data obtained by testing, measuring and/or auditing one or more Criterion at specified sampling intervals at each said Supplier's premises; and
iii. a normalised score for each said Supplier, derived from said data, wherein said score enables comparison such that one or more said Suppliers are enabled to be compared:
A. with each other;
B. within said specified Criterion;
C. within specified locations;
D. with said Suppliers in other locations;
E. with said Suppliers with similar said normalised scores for said specified Criterion; and
F. with their own said normalised scores against said specified Criterion over time;
b) a search facility wherein:
i. said Data Repository is enabled to be searched by one or more said data items; and
ii. search results are enabled to be sorted by one or more said data items including said Supplier, location, said normalised score, time, and one or more said Criterion;
c) a reporting facility wherein said search results are enabled to be sorted and published, including as a network-linked computer-generated report.

2. A system for rating risk according to claim 1 wherein said search facility is enabled to include and/or exclude selected data items such that consumers is enabled to search on criterion that is specific to their requirements.

3. A system for rating risk according to claim 1 wherein said register of details about one or more said Suppliers said data and said risk information is enabled to be maintained as confidential wherein said search facility and said reporting facility do not include confidential information.

4. A method for rating risk including the steps of:
a) accessing a risk information Data Repository having data items wherein said data items include:
i. a register of details about one or more Suppliers including each said Supplier's location(s), specialisation(s) and capacity(s);
ii. data obtained by testing, measuring and/or auditing one or more Criterion at specified sampling intervals at each said Supplier's premises; and
iii. a normalised score for each said Supplier, derived from said data, wherein said score enables comparison such that one or more said Suppliers are enabled to be compared:
A. with each other;
B. within said specified Criterion;
C. within specified locations;
D. with said Suppliers in other locations;
E. with said Suppliers with similar said normalised scores for said specified Criterion; and
F. with their own said normalised scores against said specified Criterion over time;
b) utilising a search facility wherein:
i. said Data Repository is enabled to be searched by one or more said data items; and
ii. search results are enabled to be sorted by one or more said data items including said Supplier, location, said normalised score, time, and one or more said Criterion;
c) utilising a reporting facility wherein said search results are enabled to be sorted and published, including as a network-linked computer-generated report

5. A method for rating risk according to claim 4 wherein said utilisation of said search facility has the further substep(s) of including and/or excluding selected data items such that consumers is enabled to search on criterion that is specific to their requirements.

6. A method for rating risk according to claim 4 wherein said accessing said register of details about one or more said Suppliers includes the substep of maintaining said risk information as confidential such that said search facility and said reporting facility do not include confidential information.

7. An apparatus for rating risk including:
a) a risk information Data Repository having data items wherein said data items include:
i. a register of details about one or more Suppliers including each said Supplier's location(s), specialisation(s) and capacity(s);
ii. data obtained by testing, measuring and/or auditing one or more Criterion at specified sampling intervals at each said Supplier's premises; and
iii. a normalised score for each said Supplier, derived from said data, wherein said score enables comparison such that one or more said Suppliers are enabled to be compared:
A. with each other;
B. within said specified Criterion;
C. within specified locations;
D. with said Suppliers in other locations;
E. with said Suppliers with similar said normalised scores for said specified Criterion; and
F. with their own said normalised scores against said specified Criterion over time;
b) a search facility wherein:
i. said Data Repository is enabled to be searched by one or more said data items; and
ii. search results are enabled to be sorted by one or more said data items including said Supplier, location, said normalised score, time, and one or more said Criterion;
c) a reporting facility wherein said search results are enabled to be sorted and published, including as a network-linked computer-generated report.

8. An apparatus for rating risk according to claim 7 wherein said search facility is enabled to include and/or exclude selected data items such that consumers is enabled to search on criterion that is specific to their requirements.

9. A system for rating risk according to claim 7 wherein said register of details about one or more said Suppliers said data and said risk information is enabled to be maintained as confidential wherein said search facility and said reporting facility do not include confidential information.

10. (canceled)

11. A system for rating risk according to claim 2 wherein said register of details about one or more said Suppliers said data and said risk information is enabled to be maintained as confidential wherein said search facility and said reporting facility do not include confidential information.

12. A method for rating risk according to claim 5 wherein said accessing said register of details about one or more said Suppliers includes the substep of maintaining said risk information as confidential such that said search facility and said reporting facility do not include confidential information.

13. A system for rating risk according to claim 8 wherein said register of details about one or more said Suppliers said data and said risk information is enabled to be maintained as confidential wherein said search facility and said reporting facility do not include confidential information.
